(19) United States
(12) Patent Application Publication
(10) Pub. No.: US 2024/0010090 A1
(43) Pub. Date: Jan. 11, 2024

(54) A SYSTEM AND METHOD OF FAST CHARGING A BATTERY USING COMBINED CONSTANT CURRENT AND CONSTANT VOLTAGE CHARGING

(71) Applicant: TVS MOTOR COMPANY LIMITED, Chennai (IN)

(72) Inventors: Naik Ravindar, Chennai (IN); Subramonian C, Chennai (IN)

(73) Assignee: TVS MOTOR COMPANY LIMITED, Chennai (IN)

(21) Appl. No.: 18/034,610

(22) PCT Filed: Dec. 31, 2020
(86) PCT No.: PCT/IN2020/051073

§ 371 Date: Apr. 28, 2023

(30) Foreign Application Priority Data
Oct. 29, 2020 (IN) 202041047380

(51) Int. Cl. B60L 53/62; B60L 58/13; B60L 53/10

(52) U.S. Cl. CPC B60L 53/62; B60L 58/13; B60L 53/11; B60L 58/16

(57) ABSTRACT

A charging system for a vehicle includes a charger in electronic communication with at least one control unit; and a battery management system (BMS). The charger is configured to supply constant energy in constant current mode to at least one battery for a pre-determined duration until a state-of-charge (SOC) of the at least one battery is less than a pre-determined battery state of charge (BSOC). The BMS is configured to determine a charging mode of the charger and the at least one control unit is configured to monitor the SOC continuously. The charger is configured to supply energy in the constant voltage mode (CV) when the SOC of the at least one battery is more than the pre-determined BSOC and the charger is configured to stop charging when the SOC is equal to full charge capacity of the at least one battery.

### TECHNICAL FIELD

The present subject matter relates to the battery. More particularly, the present subject matter relates to a system and method of charging a battery.

### BACKGROUND

The growing demand for lithium-ion (Li-ion) battery has expedited the need for new optimal charging approaches to improve the speed and reliability of the charging process without deteriorating the battery performances and life. Many efforts have been made to develop optimal charging strategies for commercial Li-ion batteries over the last decade. The Lithium-ion (Li-ion) batteries are being commercialized for plug-in hybrid (PHEVs) and electrical vehicles (EVs) owing to their advantages of higher energy density, longer lifespan as compared to their lead-acid and Nickle-metal hydride alternatives. The EVs or hybrid vehicles require onboard batteries to power their electric drive systems and use motor as the prime mover. However, compared to the re-fueling of a fuel-driven internal combustion engine, the battery charging process is more cumbersome and complex. Also, the Lithium-ion battery charging speed happens to be a major bottleneck for popularization of EVs.

### BRIEF DESCRIPTION OF THE DRAWINGS

The detailed description is described with reference to the accompanying figures. The same numbers are used throughout the drawings to reference like features and components.

FIG. 1 illustrates a block diagram of the elements interacting to perform the method as disclosed in the present invention.

FIG. 2 illustrates a graphical representation of Current and Voltage against Time as per an embodiment of the present invention.

FIG. 3 illustrates the flow chart for the method of fast charging a battery, as disclosed in the present invention.

### DETAILED L DESCRIPTION

Various features and embodiments of the present invention here will be discernible from the following further description thereof, set out hereunder. It is contemplated that the disclosure in the present invention may be applied to any vehicle without defeating the spirit of the present subject matter. The detailed explanation of the constitution of parts other than the present invention which constitutes an essential part has been omitted at suitable places.

Typically, the high costs of fossil-based fuel and its impact on pollution is leading to research and development of alternative means of transportation. Moreover, original equipment manufacturer (OEMs) and customers are being driven down a path to reduce carbon dioxide emissions. One feasible way is by electrifying the drivetrain which has the capability to propel vehicles while necessitating space inside the vehicles to configure large enough battery pack to deliver adequate range of usage in single charge. The electric vehicles are powered by batteries. Another feasible way includes configuring vehicles with hybrid powertrain to run with plurality of energy sources wherein one of the sources is battery. For providing a satisfying user-experience, a sufficiently-charged battery plays a very crucial role. However, it requires a significant amount of energy to Charge batteries and maintain the state of charge of these batteries. Unnecessary charging or over-charging a battery has negative impact on the battery's energy-efficiency.

Lithium-ion batteries, which are predominantly popular, operate safely within the designated operating voltages; however, the battery becomes unstable if inadvertently charged to a voltage higher than the specified voltage. For example, prolonged charging above 4 Volts on a Li-ion battery designed for 4.10 Volts/cell leads to metallic lithium plate formation on the anode which is undesirable. Also, as a result, the cathode material becomes an oxidizing agent, loses stability and produces carbon dioxide (CO2).

In general, the Li-ion battery charging strategy can be broadly divided into three categories based on the internal models. The first category is a model-free methodology, including constant-current (CC), Constant Current constant voltage (CC-CV), multi-stage CC-CV and pulse charging techniques. These approaches incorporate predefined charging profiles with fixed current, voltage, and/or power constraints. However, the responses of battery dynamics based on the input provided is ignored which leads to one or more the problems cited earlier. Therefore, this motivates and necessitates designer to explore advanced charging strategies in order to meet fast charging requirements and at the same time alleviate any adverse impact on battery state of health (SOH). The second category of charging strategies utilizes empirical models such as equivalent circuit-based models and neural network models. These models predict battery states and calculate electrical elements using past experimental data. The empirical models are computationally fast and simple, but unable to reflect physics-based parameters and battery aging. Therefore, an empirical model-oriented charging control protocol may fail to work properly after certain cycles. A third category of charging methods is based on electrochemical models governed by kinetics and transport equations which are more complex. A closed-loop optimization problem can be formulated to minimize charging time and compensate for model uncertainties and disturbances. In addition, temperature variation can also be predicted with thermally-related equations. Such electrochemistry-based control methods come close to real-time battery functioning when designed to work with a state observer. However, the intractable computation complexity arising out of such charging method and solving the associated full-order nonlinear partial differential equations (PDEs), limits the further application of this approach to a real-time charging controller.

Additionally, increasing the charging rates may cause undesirable temperature rise and accelerate side reactions in the batteries. Therefore, the trade-off between fast charge and battery health needs to be simultaneously taken into account. Therefore, optimal charging scheme for a battery has gained much attention in the research field of EVs/PHEVs. An appropriate optimal charging protocol is desirable to improve the charging efficiency, minimize any performances attenuation, and sustain a safe operation of a Lithium-ion battery (LIB) system. Usually, battery chargers are designed to charge the battery with CC-CV charging profile. In CC-CV chargers, the battery is initially charged with constant current until the battery voltage reaches a preset maximum charging voltage, then the charging voltage is held constant until the current is reduced to a preset minimum value. The charger constant voltage corresponds to the battery maximum voltage.

However, the transition from constant current to constant voltage charging is dependent on the voltage drop (I×R) of the circuit, where R represents series resistance between the charger and battery and I represent current. This transition point can be further extended by reducing the equivalent series resistance. However, it is impossible to eliminate the transition point altogether. After the transition point, the charger voltage remains constant whereas battery voltage increases as battery gets charged. This transition typically occurs at around 75 percent to 80 percent of state of charge (SOC) of the battery. It is noticed that after the transition point, the charging rate reduces drastically. Therefore, the time taken for charging the battery to 75 percent SOC with CC charging is equal to the time taken for charging the remaining 25 percent SOC with CV charging. The increase in charging time is as follows:
t_{cc}—Time taken to charge battery up to 75percent in constant current mode
   t_{cv}—Time taken to charge battery from 75 percent to 100 percent in constant voltage mode

in conventional CC-CV method of charging, typically

Thus, total charging time is as below,

l_{charging.cccv}=l_{cc}+l_{cv}

t_{charging.cccv}=2 t_{cc}

Similarly, when the battery is charged with pure constant current node without constant voltage mode:
t_{changing cc}—Time taken to charge battery by constant current mode alone till 100 percent SOC

$$\\ {t}_{charging . cc} = {t}_{cc} + \frac{{t}_{cc}}{3} = \frac{4 {t}_{cc}}{3}$$

As a result, the total charging time in CCCV mode turns out to be 1.5 times

the total charging time in CC mode as evident from below equation,

$$\\ \frac{{t}_{charging . cccv}}{{t}_{charging . cc}} = \frac{2 {t}_{cc}}{\frac{4 {t}_{cc}}{3}} = \frac{3}{2} = 1.5$$

Effectively, there is a 50 percent increase in time observed when the constant current charging is not employed. In the known arts, to reduce the time taken for charging the battery, it is proposed to charge the battery with constant current till battery is completely charged. In the known arts, on sensing that the battery is completely charged, the charging is stopped. However, in the known arts, the battery state of full charge is determined by IR′ drop, where R′ represents the series impedance. Since series impedance is a variable parameter and depends on environmental conditions, temperature of battery, SOC, life of battery etc., it is very difficult to estimate the precise value of series impedance dynamically while charging the battery. Therefore, there is a high possibility of over-charging the battery. As Li-ion batteries are temperature and voltage-sensitive, it can explode in case of overcharging. The challenge is further complicated when the charge termination is based only on cell-voltage measurement.

Hence, there is a need for development of an active, efficient, reliable, durable yet safe charging system and method in order to fulfill the overall optimal charging objective in terms of implementation, charging duration and health-conscious requirements of the battery.

Thus, a charging system and method for fast charging a battery is proposed in the present invention in order to alleviate one or more drawbacks highlighted above and other problems of known art.

It is an aspect of the present invention to provide a robust and effective SOC-based monitoring system and method for reducing the duration of charging a. battery.

It is another aspect of the present invention to provide a charging system and method for formulating an active charging strategy with optimal control method for fast charging a battery based on a pre-determined SOC value.

It is yet another aspect of the present invention to provide a charging system and method for monitoring individual cell SOC and actively balancing the SOC of individual cells in case any imbalance is detected.

It is another aspect of the present invention to provide a charging system and method for reducing the battery charging time and providing optimum battery performance and thermal management.

It is yet another aspect of the invention to provide a charging system and method for fast charging a battery which is easy to implement and maintain an optimum state of health of the battery while keeping the battery safe.

It is another aspect of the present invention to provide a charging system and method to eradicate/minimize the reactant concentration buildup at the electrode and the concentration over-potential in the battery.

It is another aspect of the present invention to provide a charging system and method for fast charging a battery with less charging time and improved charging efficiency.

It is an aspect of the present invention to provide a charging system and method for accelerating the battery charging process and lowering the peak stress on the battery.

Furthermore, the details as well as other features and advantages of this invention are set forth in the remainder of the specification and are shown in the accompanying drawings. The present subject matter is further described with reference to accompanying figures. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 illustrates a block diagram of the elements of the charging system, interacting to perform the method as disclosed in the present invention. This is an exemplary representation, and by no way is limiting the scope of the subject matter. The present invention discloses a charging system (10) and method for fast-charging a battery. Accordingly, as per an aspect of the present invention said charging system (10) involves one or more batteries (100), a battery management system (BMS) (105), a Charger (110) interactively connected in a circuit and a control unit. In one of the embodiments of the present invention, said charger (110) receives an input voltage (120). According to an aspect of the present invention, said BMS (105) is configured to receive and process data form said one or more batteries (100) and said BMS (105) and is configured to send signal to said charger (110). In one of the embodiments of the present invention said BMS (105) is configured to receive and process data from individual batteries from said one or more batteries (100). As per an aspect of the present invention, said BMS (105) is further configured to continuously monitor the state of charge (SOC) of said one or more batteries (100). In one of the embodiments of the present invention, said charger (110) is configured to charge said one or more batteries (100) in either constant current (CC) or constant voltage (CV) mode at given point of time.

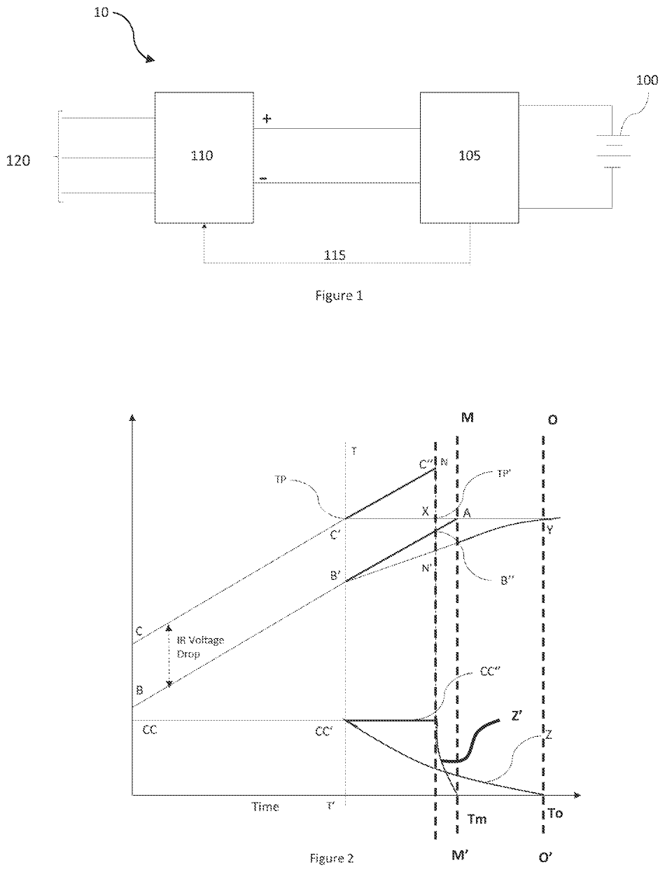

FIG. 2 illustrates a graphical representation of Current and Voltage against Time as per an embodiment of the present invention. In one of the embodiments of the present invention, a constant current and constant voltage (CC/CV) charging method is adopted with an extended constant current based on pre-determined conditions, in charging Li-ion batteries. As per an embodiment said pre-determined condition is based on the state of charge of said battery (100). In one of the embodiments of the present invention, said battery (100) is initially charged with a constant current supplied by the charger (110) until the battery voltage reaches a pre-determined (battery state of charge) BSOC, then the charging is shifted to constant voltage for slow and safer charging until said battery (100) reaches a full charge capacity state. In one of the embodiments of the present invention, said full charge capacity is a pre-determined standard maximum charge value equal to hundred percent state of charge of said battery (100). According to an embodiment of the present invention, said pre-determined (battery state of charge) BSOC of said battery (100) is in the range of 95 percent to 99.5 percent state of charge. As per an embodiment of the present invention said BMS (105) receives and processes the data from said battery (105) in order to calculate the battery state of charge. In an aspect of the present invention, said BMS (105) sends signal to said charger (110) according to said pre-determined (state of charge) BSOC of said battery (100). According to an aspect of the present invention, said BMS (105) sends signal to said charger (110) for charging said battery (100) with constant current until the state of charge of said battery (100) reaches said pre-determined (state of charge) BSOC. In an aspect of the present invention, once said battery (100) reaches said pre-determined (state of charge) BSOC, said BMS (105) sends signal to said charger (110) for changing the charging of said battery (100) to be supplied with constant voltage by the said charger (110). As per an embodiment of the present invention, said BMS (105) continuously monitors the state of charge of said battery (100). In an aspect of the present invention, said BMS (105) sends signal to said charger (110) for charging said battery (100) with constant voltage until the state of charge of said battery (100) reaches hundred percent and once the state of charge of said battery is equal to or more than hundred percent, the charging is cutoff As per an embodiment of the present invention, the constant voltage of charger (110) corresponds to the battery maximum voltage. Hence, said charging system (10) and method for fast charging as disclosed in the present invention, implements said pre-determined BSOC parameter for transitioning from constant current (CC) mode to constant voltage mode (CV). In the known arts a battery voltage can give an erroneous reading, even when the battery SOC is fully charged, which can lead to over-charging the battery. As per an additional embodiment, said charging system (10) and method of fast charging as disclosed in the present invention is independent of voltage reading and continuously monitors said SOC. Therefore, said charging system (10) and method of fast charging as disclosed in the present invention is more reliable in comparison to known voltage dependent methods.

As per an embodiment of the present invention, a line C-C′ represents charger voltage and B-B′ represents battery voltage. In one of the embodiments a transition point TP represents the switching from (constant current) CC to (constant voltage) CV in conventional CC-CV charging method. According to an embodiment, said charging system (10) and method of fast charging as per an aspect of the present invention has an extended constant current supply and a modified transition point TP′. In one of the embodiments, a line B′-B″ represents battery voltage for extended constant current charging according to said charging system (10) and method of fast charging as disclosed in the present invention. The charger voltage for constant current charging is represented by C′-C″. As per an embodiment of the present invention, said BMS (105) triggers said charger (110) at said modified transition point TP′ at said pre-determined BSOC. Thus, from said modified transition point TP′ the constant voltage charging time for full charge is reduced and thereby, the amount of time required to charge said battery (100) is reduced. Therefore, said charging system (10) and method as disclosed in the present invention provides fast charging of said battery (100) with less charging time and improved charging efficiency, improved reliability, durability and safety. Accordingly, from B″ to A is the time required for charging said battery (100) to hundred percent SOC in constant voltage method. The line CC-CC′ represents current. As per said charging system (10) and method of fast charging, battery current for extended constant current charging is represented by curve CC′-CC″. The battery current for CC-CV conventional charging method is represented by curve Z. The curve Z′ is the battery current for constant voltage charging time as per an aspect of the present invention. Here, N-N′ is the axis along said modified transition point TP′. T-T′ is the axis along which normal transition point TP lies in the known conventional CC-CV algorithm. The battery voltage for conventional CC-CV charging is represented by B′-Y. Extending line N-N′ to cut on X-axis. As per an aspect a line M-M′ passing through A cutting X-axis at Tₘ and another line passing through Y cutting X-axis at To is shown in FIG. 2. As per an aspect Tₒ−Tₘ=Tₛ, which is the time saving with the present invention fast charging method.

As per present invention, when said BSOC is set to 95%,

T_{charging.cccv}=t_{cc}+(20/75)*t_{cc}+(5/25)*t_{cc}=1.46 t_{cc}

Thus, time saving is from 1.5 times to 1.46 times if said BSOC is 95 percent, i.e. 2.6 percent reduction (1.5−1.46)/(1.5). When said BSOC is set to 99.5 percent then.

T_{charging.cccv}=t_{cc}+((24.5/ 75)*t_{cc}+(0.05/25)*t_{cc}=1.332 t_{cc}

Therefore, time saving is from 1.5 times to 1.332 times if said BSOC is 99.5 percent, i.e. 11.2 percent reduction (1.5−1332)/(1.5). As per an aspect of the present invention, said charging system (10) configured to charge as per below governing equation:

T_{charging.cccv}=t_{cc}+((BSOC−75)/75)*t_{cc}+((100−BSOC/25)*t_{cc}.

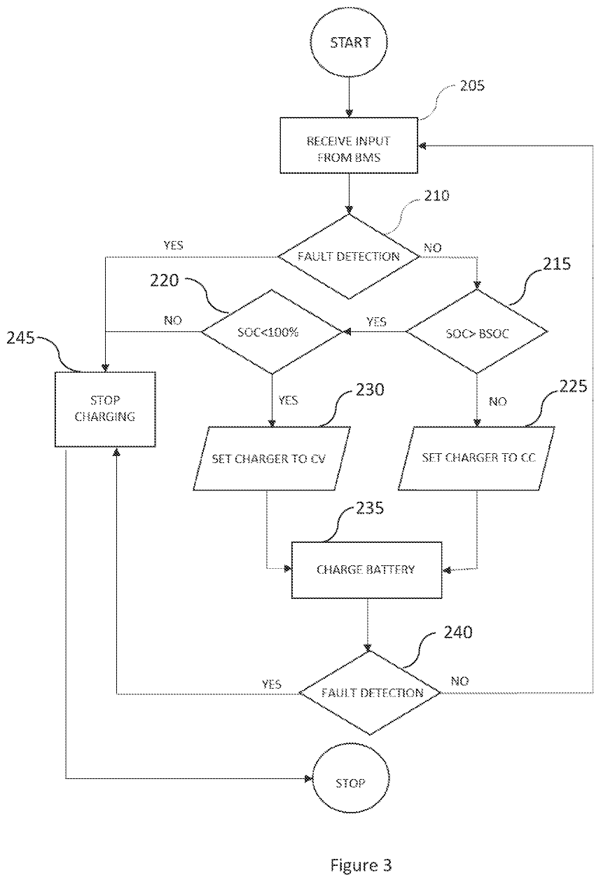

FIG. 3 illustrates the flow chart for said charging system (10) and method of fast charging a battery, as disclosed in the present invention. When the battery charging starts, the first step (205) involves reading said BMS (105) data by receiving input using the control unit. Next step (210) involves fault detection, these faults may include any fault detected in said one or more battery (100), fault detected in the circuit, etc. In case a fault is detected at step (210) a signal is sent to stop the charging process at next step (245). In case no error is detected at step (210) the control goes to next step. The next step (215) involves checking said one or more battery state of charge (SOC), if the battery state of charge (SOC) is less than said pre-determined (Battery State-of-Charge) BSOC, then said charger (110) is set to constant current (CC) mode by the control unit and said battery (100) is charged (step 235) via constant current (CC) (step 225). However, as per an embodiment of the present invention, if the state of charge of said battery (100) is greater than said pre-determined state of charge BSOC then, next step (220) involves checking whether the state of charge (SOC) of said battery (100) is less than 100 percent. According to said method of fast charging a battery, as disclosed in the present invention, if the state of charge (SOC) of said one or more battery (100) is less than 100 percent and more than said pre-determined state of charge BSOC, then said charger (110) is set to constant voltage (CV) mode for charging (step 230) said battery (100). If the state of charge (SOC) of battery is more than or equal to 100 percent (step 220) then charging is stopped (step 245). As per said charging system (10) and method of fast charging a battery said BMS (105) continuously monitors the state of charge of said one or more battery (100) and if a fault is detected (step 240) the charging is stopped. Hence, according to said charging system (10) and method of fast charging a battery as disclosed in the present invention, said battery (100) is charged with a constant current (CC) via said charger (110) until the state of charge of said battery (100) is less than said pre-determined state of charge BSOC and thereby extending the period of charging said battery (100) through constant current mode. Therefore, said charging system (10) and method as disclosed in the present invention provides an active charging method in order to fulfill the overall optimal charging objective in terms of implementation, charging duration and health-conscious requirements of said battery (100) while overcoming all problems cited earlier.

According to above architecture, the primary efficacy of the present invention is that the charging system and method provides a precise (State of charge) SOC based extended constant current charging to achieve a reduction in charging time with fast charging while still ensuring reliability, durability, life and safety of the battery unit. Thus, the battery is safe with an active charging strategy with optimal control method for fast charging a battery based on a pre-determined SOC value.

According to above architecture, the second efficacy of the present invention is that the pre-determined (state of charge) SOC whose value is configured in the range of 98-99.5 percent, results in shifting the transition point of constant current (CC) to constant voltage (CV) at a late stage thereby achieving reduced charging cycle time. This leads to battery being charged in fast charge mode i.e. with constant current for higher duration and enables configuring the transition point to constant voltage charge mode to be as close as possible to full charge condition. Thus, overall, significantly reducing the duration of charging a battery. Hence, above method additionally provides simple, cost-effective and precise solution.

Further, the number of batteries can be altered depending on the requirement. For example, the stack of batteries may be constituted by three batteries or five batteries or more,

Thus, even when the number of batteries involved is changed, an optimum charging of the batteries can be realized by the method using the BMS. As a result, the charging system and method of fast charging a battery as disclosed in the present invention can be applied to various types of batteries by accordingly selecting the pre-determined state of charge.

### LIST OF REFERENCE NUMERALS

10 Charging System
100 Battery
105 BMS (Battery Management System)
110 Charger
115 Signal sent from BMS to charger
120 Input supply received by charger
BSOC Pre-determined state of charge
CC Constant Current
CV Constant Voltage

1-6. (canceled)

7. A charging system for a vehicle, including:
a charger in electronic communication with at least one control unit; and
a battery management system (BMS),
wherein
the charger is configured to supply constant energy in constant current mode to at least one battery for a pre-determined duration until a state-of-charge (SOC) of the at least one battery is less than a pre-determined battery state of charge (BSOC), and the charger is configured to supply energy in a constant voltage mode (CV) when the SOC of the at least one battery is more than or equal to the pre-determined BSOC;
wherein the BMS is configured to determine a charging mode of the charger and the at least one control unit is configured to monitor the SOC continuously; and
wherein the charger is configured to supply energy in the constant voltage mode (CV) when the SOC of the at least one battery is more than the pre-determined BSOC and the charger is configured to stop charging when the SOC is equal to full charge capacity of the at least one battery.

8. The charging system as claimed in claim 7, wherein the pre-determined BSOC is a parameter for transitioning from constant current mode to constant voltage mode (CV) and a value of the pre-determined BSOC is in range from 95 percent to 99.5 percent of rated maximum voltage of the at least one battery.

9. The charging system as claimed in claim 7, wherein constant voltage of the charger corresponds to a rated maximum voltage of the at least one battery.

10. A method of fast charging at least one battery, the method comprising:
monitoring continuously health data of the at least one battery through a battery management system (BMS), using at least one control unit;
reading a state-of-charge (SOC) of the at least one batter
setting a charger to constant current mode and supplying constant current for fast charging the at least one battery, when the SOC of the at least one battery is detected to be less than a pre-determined battery state of charge (BSOC);
setting the charger to constant voltage mode (CV) and supplying constant voltage for slow and safer charging of the at least one battery, when the SOC of the at least one battery is more than the pre-determined BSOC and less than a fill charge capacity of the at least one battery; and
stopping charging the at least one battery if the SOC is equal to the full charge capacity of the at least one battery.

11. The method as claimed in claim 10, wherein the pre-determined BSOC of the at least one battery is in a range of 95 percent to 99.5 percent of rated maximum voltage of the at least one battery.

12. The method as claimed in claim 10, wherein the full charge capacity of the at least one battery is a predetermined standard maximum charge value equal to 100 percent state of charge of the at least one battery.
